(19) United States
(12) Patent Application Publication
(10) Pub. No.: US 2008/0085488 A1
(43) Pub. Date: Apr. 10, 2008

(54) Universal one-step drill

(76) Inventor: Sargon Lazarof, Encino, CA (US)

Correspondence Address: SARGON LAZAROF;SARGON ENTERPRISES, INC., 16101 VENTURA BLVD, SUITE 350, ENCINO, CA, 91436, US

(21) Appl. No.: 11/511,965

(22) Filed: Aug. 29, 2006

(51) Int. Cl. A61C 3/00

(52) U.S. Cl. 433/50

(57) ABSTRACT

A universal one-step drill for heat sensitive material, particularly for bone surgery, comprising a pyramidal shaped, sharply pointed first stage, which tapers to a first diameter and one or more subsequent stages, each of which tapers out to a larger diameter.

### FIELD OF THE INVENTION

This invention relates to a drill for use with heat sensitive surfaces.

### BACKGROUND OF THE INVENTION

The drill of this invention is particularly useful in surgery involving bone, such as dental surgery for the production of cavities in a patient for the insertion of dental implants. Other uses of the drill of this invention include orthopedic surgery and cutting into hard or calcified tissue.

When a tooth is extracted from a patient's mouth, the resulting cavity has a natural tapered shape. In all of the methods of placing the tubular body portion of an implant into the bore drilled into the bone of the patient, multiple drills are required to correctly size and shape the bore. This requires the surgeon using a particular drill, stopping to replace the drill with another drill of a second proper size and often repeating this procedure at least three times. This wastes time and energy of the surgeon and extends the time that the patient must remain in surgery and under anesthetic. Every time the drill is changed to the next size, it introduces inaccuracies in the bore. Also, these drills can generate heat that can burn and destroy surrounding bone cells.

### BRIEF DESCRIPTION OF THE INVENTION

This invention provides a universal one-step drill for use with heat sensitive surfaces, such as producing a bore in a patient's bone. This one-step universal drill is utilized to replace what previously required multiple steps with multiple separate drills, at times, up to five steps and five drills. This includes a tissue punch and final drill where the bore is enlarged to a final size and opening, so that the final drill does not shatter or jump around while going in the previous bore size. While the description has been particularly related to dental implants, this universal one-step drill can be used for other types of surgery requiring drilling a bore in a patient's bone, such as orthopedic surgeries involving prosthetic devices, such as hip and ankle surgery.

The first stage of the drill is unique in that it is sharply pointed at the insertion end, is pyramidal in shape and tapers out to a defined diameter. This can be used alone as a starting drill only, to make an initial starting point for insertion. Because of it's sharp point it makes a starting point with ease and without movement. Also, the drill can have one or more additional stages, depending upon need.

### OBJECTS OF THE INVENTION

It is an object of the invention to provide a universal one-step drill bit for producing a bore in bone, which greatly reduces the time to create the bore.

Another object of the invention is to provide a universal one-step drill, which is safer, more accurate in cutting and more convenient for both the surgeon and the patient.

Yet another object of the invention is to provide a universal one-step drill, which is faster in cutting, yet more accurate, and is less destructive to the surrounding bone.

### BRIEF DESCRIPTION OF THE DRAWINGS

FIG. 1 is an elevational view of one embodiment of the drill of this invention;

FIG. 2 is an elevational view of the drill of FIG. 1, rotated 90 degrees; and,

FIG. 3 is an elevational view of another embodiment of the drill of this invention.

### DETAILED DESCRIPTION OF THE INVENTION

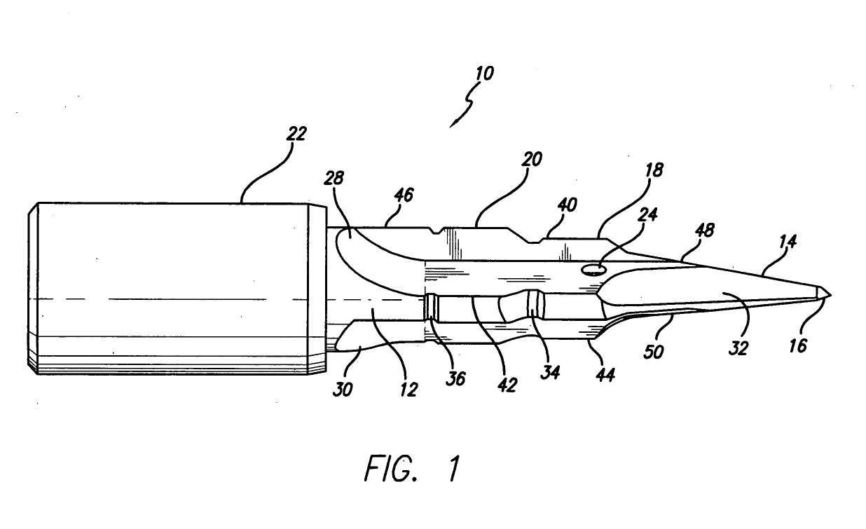

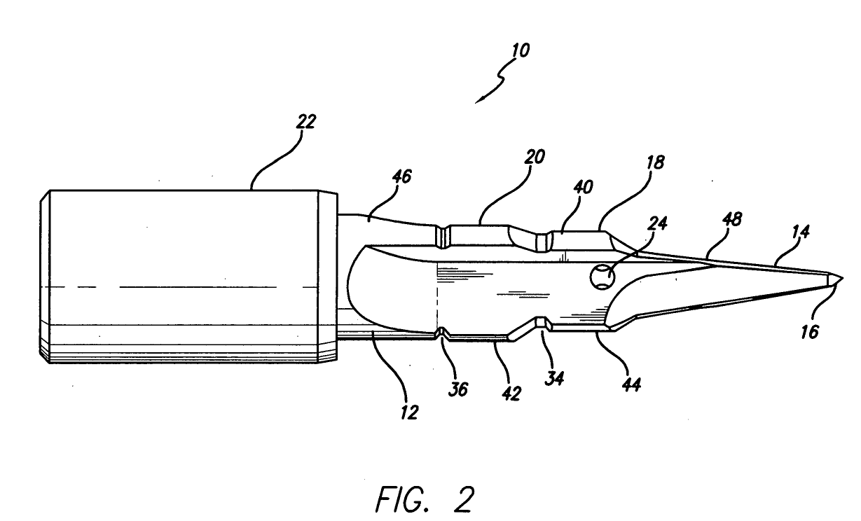

Referring now to FIGS. 1 and 2, there is shown, a first embodiment of the drill 10 of this invention. Drill 10 comprises a cylindrical body 12 having three major sections or stages. Stage 14 is substantially pyramidal in shape, drawing to a sharp point 16. In the prior art, the standard practice is to use as the first drill, a round or Rosset drill, to make an initial notch. This has been necessary to avoid the problem of the first drill not being able to form a proper starting point for insertion. Due to the sharp point 16 of the drill of this invention, it is quite easy to form an insertion point and this replaces the round first drill. While three sections or stages are described in this embodiment, there may be only one or more stages, depending upon need. The first, sharply pointed stage, which tapers out to a larger diameter is unique in itself, and may be used without additional stages, if desired and proper for the particular surgery involved.

Stage 14 tapers out to about 1.5 mm to about 2.5 mm, preferably about 2 mm in diameter and the drill is inserted to the length of section 14, which is about 4 to about 6 mm, preferably about 5 mm in length. This replaces the prior art second or pilot drill. The next stage of drill 10 is the guide drill 18, which tapers out to about 2 mm to about 3 mm, preferably about 2.5 mm in diameter and is about 2 mm to about 4 mm, preferably about 3 mm in length. The drill, which is operating continuously, no stop is necessary, is inserted through the length of section 18. In the prior art a new separate drill would be used to accomplish this third step, requiring the surgeon to stop, remove the second drill and change to the third drill.

The next and final stage 20 tapers out to about 2.5 mm to about 3.5 mm, preferably about 3 mm in diameter, which is the desired diameter for the bore at the gum line. The surgeon determines the depth to which the third section 20 is inserted. Again, in the prior art a fourth separate drill would be used for this step, requiring another stop and change of drills by the surgeon.

The universal one-step drill described accomplishes all four steps with only one drill, which is operated continuously, without stopping. This benefits the patient in shortening the time of surgery and benefits the surgeon in the speed, accuracy and ease of operation, as well as less damage to surrounding tissue, from heat.

Drill 10 has a drive shank 22 and also has a longitudinal irrigation channel through the center, which ends in an outlet hole 24, for irrigation of the surgery site during the surgical process.

Drill 10 has one or more flutes, in this embodiment a plurality of flutes, 28, 30 and 32, which are designed to carry loose bone tissue, which has been drilled out, to be carried upward and out, away from the drill and the drill site. These flutes are preferred but optional.

Drill 10 also has a series of notches 34 and 36, which are depth markers to guide the surgeon on just how deep he has drilled.

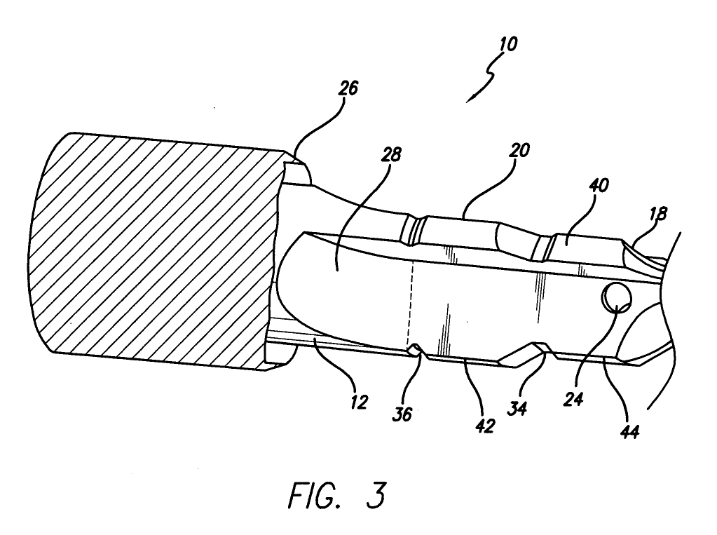

FIG. 3 shows another embodiment of the invention in which the same basic drill 10 has a tissue punch 26 with a cutting edge, added to the drill. Tissue punch 26 is utilized where there is no existing hole from an extracted tooth present and a larger bore must be created at the gum line. This drill accomplishes a fifth step.

The universal one-step drill of this invention is very steady and yet drills very quickly so that only low heat is generated and the bone, or other heat sensitive material, 1 does not burn. The low heat generated makes the drill useful for any heat sensitive surface.

The cutting edges of the drill 40, 42, 44, 46, 48 and 50, are adjacent the flutes on both sides. The drill is preferably made of stainless steel or any other material normally used for drilling bone or heat sensitive materials.

Having thus described the invention,

I claim:

1. A universal one-step drill for use on heat sensitive material, having a plurality of stages, comprising a pyramidal shaped, sharply pointed first stage, which tapers to a first diameter, a second stage which tapers out to a larger diameter than the first stage, one or more subsequent stages, each of which tapers out to a larger diameter.

2. The drill of claim 1 further comprising one or more flutes for removal of heat sensitive material.

3. The drill of claim 1 further comprising a longitudinal irrigation channel through the drill to carry cooling fluid to an outlet hole to flush the heat sensitive material.

4. The drill of claim 1 further comprising a series of depth markers.

5. The drill of claim 4 in which the depth markers are notches in the drill.

6. The drill of claim 1 in which there are at least two stages.

7. The drill of claim 1 in which there are three stages.

8. The drill of claim 1 in which there are five stages.

9. The drill of claim 7 in which the first stage tapers out to about 2 mm in diameter, the second stage tapers out to about 2.5 mm in diameter and the third stage tapers out to about 3 mm in diameter.

10. The drill of claim 1 further comprising a tissue punch as the final stage.

11. A universal one-step drill for bone surgery, having a plurality of stages, comprising a pyramidal shaped, sharply pointed first stage, which tapers to a first diameter, a second stage which tapers out to a larger diameter than the first stage, one or more subsequent stages, each of which tapers out to a larger diameter and one or more flutes for removal of bone tissue.

12. The universal one-step drill of claim 11 wherein the drill is used for dental surgery.

13. The universal one-step drill of claim 11 further comprising a longitudinal irrigation channel through the drill to carry cooling fluid to an outlet hole to flush the heat sensitive material.

14. The drill of claim 11 further comprising a series of depth markers.

15. The drill of claim 13 in which the depth markers are notches in the drill.

16. The drill of claim 11 in which there are at least two stages.

17. The drill of claim 11 in which there are three stages.

18. The drill of claim 11 in which there are five stages.

19. The drill of claim 17 in which the first stage tapers out to about 2 mm in diameter, the second stage tapers out to about 2.5 mm in diameter and the third stage tapers out to about 3 mm in diameter.

20. The drill of claim 11 further comprising a tissue punch as the final stage.

21. A universal one-step drill for creating a bore in bone for dental implant surgery, having a plurality of stages, comprising a pyramidal shaped, sharply pointed first stage, which tapers to a first diameter, and one or more subsequent stages, each of which tapers out to a larger diameter.

22. The universal one-step drill of claim 21 further comprising one or more flutes for removal of bone tissue.

23. A universal one-step drill for dental implant surgery, having a plurality of stages, comprising a pyramidal shaped, sharply pointed first stage, which tapers to a first diameter, a second stage which tapers out to a larger diameter than the first stage, one or more subsequent stages, each of which tapers out to a larger diameter; one or more flutes for removal of bone tissue and a longitudinal irrigation channel through the drill to carry cooling fluid to an outlet hole to flush the surgery site.

24. The drill of claim 23 further comprising a tissue punch as the final stage.

25. A pyramidal shaped drill for use on heat sensitive material, having a sharply pointed insertion end which then tapers out to a wider diameter.

26. The drill of claim 25 further comprising one or more flutes for removal of heat sensitive material.

27. A universal one-step drill for use on heat sensitive material, comprising a pyramidal shaped, sharply pointed first stage, which tapers to a first diameter and one or more subsequent stages, each of which tapers out to a larger diameter.

28. The drill of claim 27 further comprising one or more flutes for removal of heat sensitive material.
